(19) United States
(12) Patent Application Publication
(10) Pub. No.: US 2011/0038979 A1
(43) Pub. Date: Feb. 17, 2011

(54) Die unit and method of manufacturing die unit

(75) Inventor: Tooru Kumamoto, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki-shi (JP)

(21) Appl. No.: 12/805,205

(22) Filed: Jul. 19, 2010

(30) Foreign Application Priority Data
Aug. 17, 2009 (JP) 2009-188757

(51) Int. Cl. B29C 33/30; B23P 11/00

(52) U.S. Cl. 425/411; 29/428

(57) ABSTRACT

A die unit that maintains uniform quality of a work despite continuous operation is provided. The die unit includes a lower die holder including a base hole, an upper die holder including a through hole, a pillar having an end portion inserted to the base hole and the other end portion slidably inserted through the through hole, so as to allow the upper die holder to slide toward and away from the lower die holder, an annular bushing attached to the through hole so as to slide along the pillar, and a die element and a punch attached to one of the lower die holder and the upper die holder respectively. A spacer is provided at least one of between an inner circumferential surface of the through hole and the bushing, and between an inner circumferential surface of the base hole and the pillar, and the spacer has lower thermal conductivity than the upper die holder or the lower die holder on which the spacer is provided.

This application is based on Japanese patent application No. 2009-188757, the content of which is incorporated hereinto by reference.

### BACKGROUND

1. Technical Field

The present invention relates to a die unit, and a method of manufacturing the die unit.

2. Related Art

Die units including a punch and a die element for pressing a work are widely employed. For example, the die unit is employed for bending or cutting an outer lead of a semiconductor device.

Generally, the die unit includes a lower die installed on a work table and an upper die driven to vertically reciprocate along a pillar connected to the lower die, and presses the work with a punch attached to the upper die and a die element mounted on the lower die. In the upper die, a bushing that slides along the pillar is embedded as a guide.

Various proposals have so far been made on the die unit, including the following literature.

JP-A No. 2001-191132 discloses an annular bushing, serving-as the guide for the pillar made of a ceramic material or a super hard alloy, having a double-layer structure in which the outer layer is constituted of a highly elastic material and the inner layer is constituted of a friction-resistant material.

JP-U No. 3095850 discloses a die unit in which an aluminum alloy is employed as the base of the upper die, and an iron alloy is employed as the base of the lower die.

JP-A No. H11-90559 discloses a die unit in which the pillar is made of a ceramic material, and the guide bushing that slides along the pillar is made of a super hard alloy or a ceramic material.

Patent document 1 JP-A No. 2001-191132

Patent document 2 JP-U No. 3095850

Patent document 3 JP-A No. H11-90559

Recently, requirement for uniformity in quality of the work is becoming more and more severe.

With the technique proposed by the foregoing literature, however, it is difficult to maintain accuracy in relative position between the punch and the die, because repeated vertical reciprocation of the upper die generates frictional heat between the pillar and the bushing, which causes thermal expansion of the upper die and the base of the lower die.

To be more detailed, the heat generated by the continuous sliding friction between the pillar and the bushing is transmitted to the base of the upper die (hereinafter, upper die holder) through the bushing, and to the base of the lower die (hereinafter, lower die holder) through the pillar. The frictional heat transmitted to the upper die holder and the lower die holder is locally conducted to the periphery of the bushing in the upper die holder, and to a region on the lower die holder close to the pillar. The upper die holder and the lower die holder thus locally heated incur local thermal distortion, which causes displacement in mounting position and angle of the punch and the die element with respect to the corresponding holders. Besides, the local thermal distortion in the periphery of the bushing and the pillar causes deviation of erection angle of the pillar with respect to the holder, resulting in deviation of relative orientation between the upper die and the lower die.

Thus, the continuous operation of the die unit gradually produces deviation of positional relationship between the punch and the die, which degrades the uniformity in processing result of the work.

### SUMMARY

In one embodiment, there is provided a die unit, comprising:

a lower die holder including a base hole;

an upper die holder including a through hole;

a pillar having an end portion inserted to the base hole and the other end portion slidably inserted through the through hole, so as to allow the upper die holder to slide toward and away from the lower die holder;

an annular bushing attached to the through hole so as to slide along the pillar;

a die element and a punch attached to one of the lower die holder and the upper die holder respectively; and

a spacer provided at least one of between an inner circumferential surface of the through hole and the bushing, and between an inner circumferential surface of the base hole and the pillar;

wherein the spacer has lower thermal conductivity than the upper die holder or the lower die holder on which the spacer is provided.

The die unit thus constructed includes the spacer having lower thermal conductivity than at least one of the upper die holder and the lower die holder, located between the bushing or the pillar and the die holder, and thereby blocks heat transmission from the bushing or the pillar to the die holder. Such structure restricts the frictional heat generated between the bushing and the pillar from reaching the die holder despite continuous vertical reciprocation of the upper die, thereby minimizing thermal distortion of the die holder.

In another embodiment, there is provided a method of manufacturing a die unit, comprising:

forming a through hole through an upper die holder with a first positional accuracy;

attaching to the through hole an annular spacer having lower thermal conductivity than the upper die holder;

cutting an inner circumferential surface of the spacer with a second positional accuracy higher than the first positional accuracy;

attaching a bushing to the inner circumferential surface of the spacer that has been cut;

inserting a pillar into a base hole provided on a lower die holder; and

slidably inserting the pillar through the bushing.

The method thus arranged enables obtaining a die unit that can minimize thermal distortion of the die holder originating from frictional heat generated by continuous vertical reciprocation of the upper die. Also, the method allows setting the pillar and the bushing with high positional accuracy on the die holder, whatever the material of the die holder may be, thereby assures excellent sliding performance between the pillar and the bushing. Such structure suppresses generation of the frictional heat because of the vertical reciprocation of the upper die, thereby further contributing to minimize the thermal distortion of the die holder originating from the frictional heat.

Although the present invention refers to the upper and lower position and vertical direction, such description is adopted only for the sake of convenience in explaining the relative position of the constituents, which does not always agree with the direction of gravity, and not intended to limit the direction in actual execution of the present invention.

The constituents of the present invention do not necessarily have to be individually independent, but may be configured such that a plurality of constituents constitutes a single member, that a constituent is composed of a plurality of members, that a constituent is a part of another constituent, that a part of a constituent and a part of another constituent overlap, and so forth.

Although a plurality of steps may be sequentially mentioned in the description of the manufacturing process of the die unit according to the present invention, such sequence does not necessarily limit the actual arrangement of the manufacturing process, unless expressly noted. Also, the plurality of steps does not have to be executed at different timings from each other, but may be arranged such that a step is executed during execution of another, that the execution timing of a step and that of another partly or entirely overlap, and so forth, unless expressly noted.

Thus, the present invention provides a die unit that maintains uniform quality of the work despite continuous operation, and a method of manufacturing such die unit.

### BRIEF DESCRIPTION OF THE DRAWINGS

The above and other objects, advantages and features of the present invention will be more apparent from the following description taken in conjunction with the accompanying drawings, in which:

FIG. 1A is a schematic front view of a die unit according to a first embodiment of the present invention, and 1B is a cross-sectional view taken along a line B-B in FIG. 1A;

FIG. 2 is a schematic front view showing the die unit in a pressing action;

FIG. 3A is a perspective view of a spacer, and 3B is a cross-sectional view taken along a line B-B in FIG. 3A;

FIGS. 4A and 4B are a schematic plan view and a front view respectively, of a semiconductor device pressed by the die unit according to the first embodiment;

FIGS. 5A to 5C are schematic front views sequentially showing a pressing process of a lead of a semiconductor device;

FIGS. 6A to 6C are schematic front views sequentially showing another pressing process of a lead of a semiconductor device;

FIG. 7 is a schematic front view showing thermal conduction in the die unit according to the first embodiment;

FIG. 8 is a schematic plan view showing thermal conduction in an upper die according to the first embodiment;

FIGS. 9A to 9C are plan views for explaining a manufacturing method of the die unit according to the first embodiment;

FIG. 10 is a schematic front view of a die unit according to a second embodiment of the present invention;

FIGS. 11A and 11B are a schematic plan view and a right-side lateral view respectively, of an upper die according to a third embodiment of the present invention;

FIGS. 12A and 12B a schematic plan view and a right-side lateral view respectively, of a lower die according to the third embodiment, and 12C is a cross-sectional view taken along a line C-C in FIG. 12A;

FIG. 13 is a schematic front view showing how air flows while the die unit according to the third embodiment is working;

FIG. 14 is a schematic front view showing thermal conduction in a conventional die unit; and

FIG. 15 is a schematic front view showing thermal conduction in an upper die of the conventional die unit.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be described hereunder, referring to the drawings. In all the drawings, the same constituents will be given the same numeral, and detailed description thereof will not be repeated.

### First Embodiment

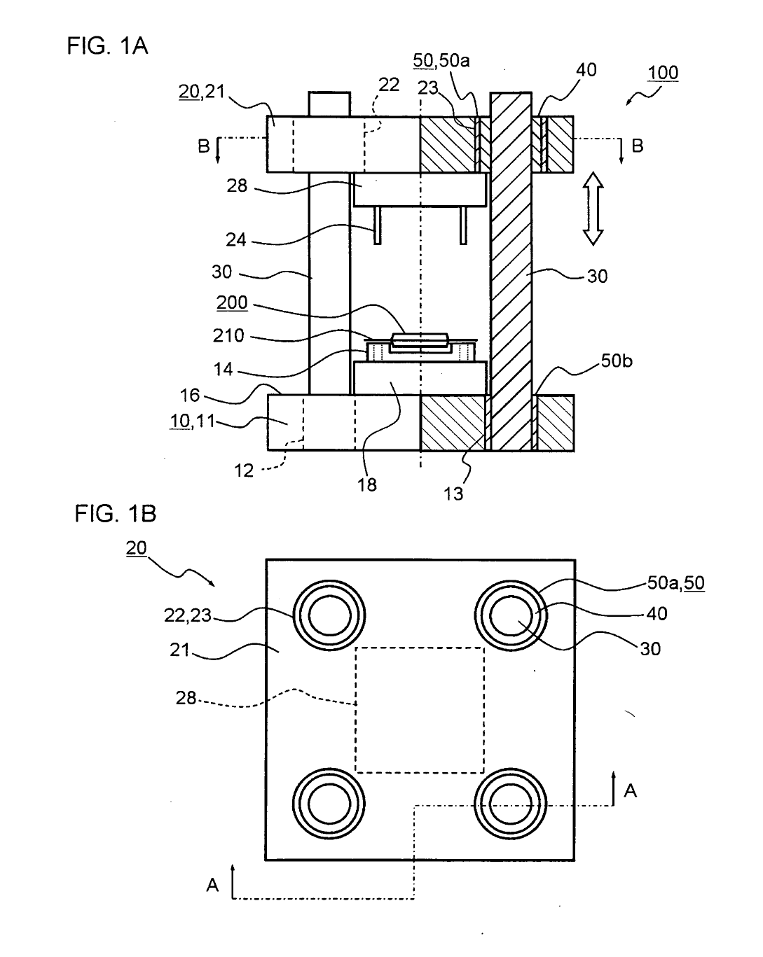

FIG. 1A is a schematic front view of a die unit 100 according to this embodiment, and 1B is a cross-sectional view taken along a line B-B in FIG. 1A. Here, FIG. 1A is a cross-sectional view taken along a line A-A in FIG. 1B, and hence the right-hand half of FIG. 1A shows a vertical cross-section of the die unit 100.

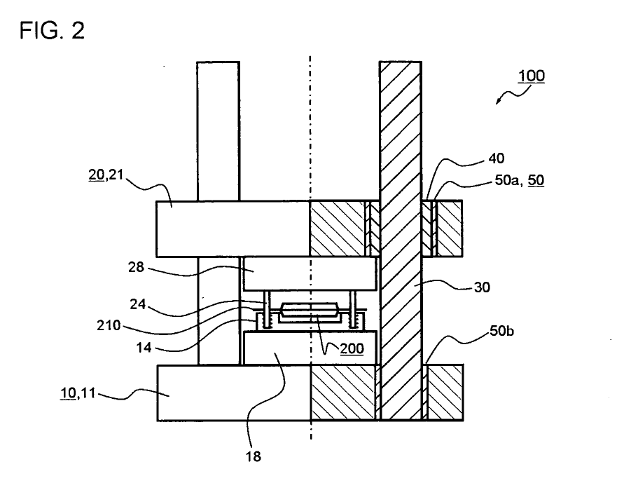

FIG. 2 is a schematic front view showing the die unit 100 in a pressing action.

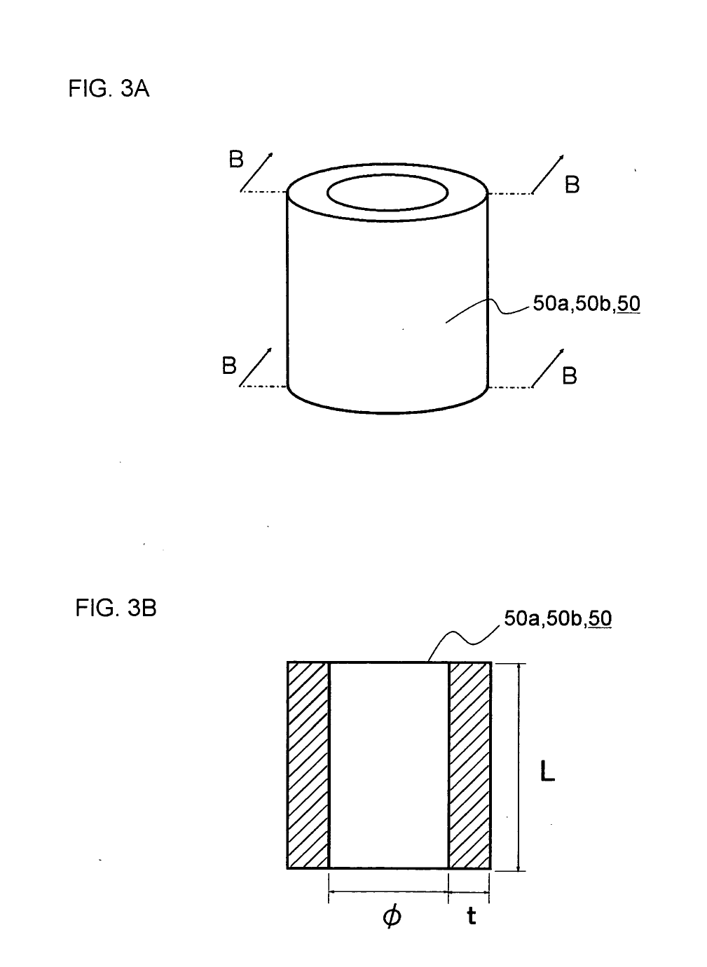

FIG. 3A is a perspective view of a spacer 50, and 3B is a vertical cross-sectional view taken along a line B-B in FIG. 3A.

### Die Unit

First, a general structure of the die unit 100 according to this embodiment will be described.

The die unit 100 according to this embodiment includes a lower die holder 11, an upper die holder 21, pillars 30, bushings 40, a die element 14 and a punch 24.

The lower die holder 11 includes base holes 12, and the upper die holder 21 includes through holes 22.

An end portion of the pillar 30 is inserted into the base hole 12 and the other end portion is slidably inserted through the through hole 22, so that the upper die holder 21 can move up from and down to the lower die holder 11.

The bushing 40 is of an annular shape and attached to the through hole 22, so as to slide along the pillar 30.

The die element 14 and the punch 24 are respectively mounted on one of the lower die holder 11 and the upper die holder 21.

The die unit 100 further includes a spacer 50, at least one of between an inner circumferential surface 23 of the through hole 22 and the bushing 40, and between an inner circumferential surface 13 of the base hole 12 and the pillar 30, and the thermal conductivity λ₁ of the spacer 50 is lower than the thermal conductivity λ₂ of the upper die holder 21 or the lower die holder 11, to which the spacer 50 is attached.

The die unit 100 according to this embodiment will be described in further details hereunder.

The die unit 100 is employed to press a work. The work is herein exemplified by a semiconductor device 200 including a plurality of leads 210.

The die unit 100 serves as a lead cutter that cuts the lead 210 in a predetermined length, and as a lead bender that bends the lead 210 into a predetermined shape.

The die unit 100 includes an upper die 20 and a lower die 10, connected by the pillars 30, such that the upper die 20 and the lower die 10 can relatively move toward and away from each other.

The upper die 20 is constituted of the upper die holder 21 serving as a base of the upper die 20, the punch 24 that cuts the lead 210 of the semiconductor device 200, and a punch plate 28 to which the punch 24 is attached and fixed.

The lower die 10 is constituted of the lower die holder 11 serving as a base of the lower die 10, the die element 14 located at the position opposing a blade tip of the punch 24, and a die plate 18 to which the die element 14 is attached and fixed.

In this embodiment, the upper die 20 with the punch 24 is set as a moving part and the lower die 10 with the die element 14 as a fixed part, however the present invention is not limited to such structure. For example, the punch 24 may be mounted on the lower die 10 and the die element 14 on the upper die 20, and the upper die 20 may be fixed and the lower die 10 may be driven to move.

The upper die holder 21 and the lower die holder 11 are of a square shape in a plan view (along the moving direction of the upper die 20), and the punch plate 28 and the die plate 18 are located at a generally central position of the upper die holder 21 and the lower die holder 11, respectively.

As shown in FIG. 1A, the upper die 20 is engaged with the pillars 30 with the punch 24 directed downward, and the lower die 10 is engaged with the pillars 30 with the die element 14 facing upward.

The upper die holder 21 includes the through holes 22 at four corners so as to surround the punch plate 28.

On the lower die holder 11, the base holes 12 are located at four corners so as to oppose the respective through holes 22.

The base hole 12 may be a through hole formed so as to penetrate throughout the lower die holder 11 in a thicknesswise direction, or a blind hole formed on an upper face 16 of the lower die holder 11. In this embodiment, the base holes 12 of the lower die 10 are through holes.

To the through hole 22 of the upper die holder 21, the bushing 40 is attached. The bushing 40 is of an annular shape and slidable along the pillar 30.

The length of the bushing 40 (size along the hole) is not specifically limited, and the proportion of the length thereof with respect to the thickness of the upper die holder 21 is not limited either.

In the upper die 20 according to this embodiment, the length of the bushing 40 and the thickness of the upper die holder 21 are equal, and the bushing 40 is attached inside each of the four through holes 22.

Here, a portion of the bushing 40 may protrude outside the through hole 22, and the bushing 40 may be offset with respect to the through hole 22 in a thicknesswise direction of the upper die holder 21.

The pillar 30 is of a column shape, and an end portion (lower end) thereof is fixedly inserted in the base hole 12, and the other end portion (upper end) is slidably inserted through the bushing 40.

The upper die holder 21 and the lower die holder 11 are connected by three or more (in this embodiment, four) pillars 30 disposed parallel to each other.

Accordingly, the upper die holder 21 is disposed so as to oppose the lower die holder 11 and to vertically reciprocate to and from the lower die holder 11, as shown in FIG. 2.

Thus, the pillar 30 and the bushing 40 constitute a die guide that allows the upper die holder 21 to relatively move up from and down to the lower die holder 11, longitudinally of the pillar 30.

The outer shape of the pillar 30 and inner circumferential shape of the annular bushing 40 are not specifically limited. In this embodiment, the pillar 30 is of a circular column shape, and the bushing 40 is of a circular ring shape.

As a material of the pillar 30 and the bushing 40, it is preferable to employ a metal such as a bearing steel equivalent to SUJ2 (JIS), from the viewpoint of mutual slidability and friction resistance.

The die unit 100 according to this embodiment includes the spacer 50 that blocks frictional heat generated between the bushing 40 and the pillar 30, provided in the upper die holder 21 and the lower die holder 11.

To be more detailed, the die unit 100 according to this embodiment includes the spacer 50 (50a, 50b) between the inner circumferential surface 23 of the through hole 22 and the bushing 40 (50a), and between the inner circumferential surface 13 of the base hole 12 and the pillar 30 (50b).

The shape and size of the spacer 50a, 50b may be the same as or different from each other. In this embodiment, the spacer 50a is attached to the outer circumferential surface of the bushing 40, which is attached on an outer circumferential surface of the pillar 30, while the spacer 50b is attached directly to the outer circumferential surface of the pillar 30. Accordingly, the spacer 50a has a larger inner diameter than that of the spacer 50b. In this embodiment, the spacer 50a and the spacer 50b has the same wall thickness.

As shown in FIGS. 3A and 3B, the spacer 50a, 50b according to this embodiment is of a hollow cylindrical (circular ring) shape. The inner diameter p of the spacer 50a corresponds to the outer diameter of the bushing 40, and the inner diameter φ of the spacer 50b to the outer diameter of the pillar 30.

The inner diameter φ of the spacer 50a, 50b may be set in a range of approx. 10 mm to 40 mm. It is preferable that the length L of the spacer 50a, 50b is greater than or equal to φ. Increasing the inner diameter φ of the spacer 50a, 50b leads to restricting the area on the lower die holder 11 and the upper die holder 21 where the die plate 18 and the punch plate 28 are to be mounted, and making the drilling work of the base hole 12 and the through hole 22 more difficult. Accordingly, it is preferable to set the inner diameter ₉ of the spacer 50a, 50b at approx. 10 mm. Also, it is preferable to set the wall thickness t of the spacer 50a, 50b at approx. 2 mm or more, from the viewpoint of blocking performance against the frictional heat generated between the pillar 30 and the bushing 40, and mechanical strength.

As a material of the spacer 50a, 50b, it is preferable to employ a hard material, specifically 55 or higher by Scale C of Rockwell Hardness (HRC), from the viewpoint of friction wear resistance of the interface with the bushing 40 and the pillar 30, and also high accuracy required in the cutting process, which will be described later.

The thermal conductivity λ₁ (λ₁ₐ) of the spacer 50a is lower than that λ₂ (λ₂ₐ) of the upper die holder 21, and the thermal conductivity λ₁ (λ_{1b}) of the spacer 50b is lower than that λ₂ (λ_{2b}) of the lower die holder 11.

Specifically, the upper die holder 21 and the lower die holder 11 may be constituted of an aluminum-based material, and the spacer 50 (50a, 50b) of an iron-based material.

Examples of the aluminum-based material include an aluminum alloy, and those of the iron-based material include a carbon steel and a stainless steel.

Alternatively, the spacer 50 may be constituted of a resin or a ceramic material. It should be noted, however, that a metal such as the iron-based material provides higher impact strength to the spacer 50. In this case, even though the spacer 50 suffers a hammering impact when the pillar 30 or bushing 40 is mounted on or removed from the upper die holder 21 or the lower die holder 11, the spacer 50 can be exempted from deformation or crack.

It is preferable to employ the same material to form the upper die holder 21 and the lower die holder 11. In this case, the upper die holder 21 and the lower die holder 11 present equal thermal deformation owing to a change in ambient temperature in the site where the die unit 100 is installed, thereby suppressing deviation of the relative position or angle between the die element 14 and the punch 24. Also, the same cutting tool can be employed in common in the manufacturing process of the upper die holder 21 and the lower die holder 11, and therefore fluctuation of cut dimensions between the upper die holder 21 and the lower die holder 11 can be suppressed.

Also, setting the thermal conductivity λ₂ of the upper die holder 21 and the lower die holder 11 higher than that λ₁ of the spacer 50 allows, in the case where the heat has intruded from outside into the die unit 100, efficiently diffusing and dissipating the heat over the plane of the upper die holder 21 and the lower die holder 11. Accordingly, the die unit 100 according to this embodiment suppresses deviation of the relative position or angle between the die element 14 and the punch 24 arising from the heat intruding from outside toward the upper die holder 21 and the lower die holder 11.

Here, the thermal conductivity of the aluminum alloy is approx. 200 [W/m·K] or higher, and that of the carbon steel or stainless steel is 100 [W/m·K] or lower. It is preferable that the thermal conductivity of the spacer 50a and the spacer 50b does not exceed a half of that of the upper die holder 21 and the lower die holder 11, respectively. Such setting allows effectively blocking, with the spacer 50a and 50b, a heat flux flowing from the bushing 40 and the pillar 30 toward the upper die holder 21 and the lower die holder 11.

Also, employing the aluminum-based material to form the upper die holder 21 and the lower die holder 11 contributes to reducing the weight of the die unit 100 when compared with the iron-based material, thereby facilitating execution of various relevant works.

In the case where the spacer 50, the lower die holder 11 or the upper die holder 21 is constituted of a combination of a plurality of materials, the thermal conductivity λ₁ of the spacer 50 and the thermal conductivity λ₂ of the upper die holder 21 or the lower die holder 11 are to be construed as an average thermal conductivity in the vicinity of the contact interface between the lower die holder 11 or the upper die holder 21 and the spacer 50.

Regarding the frictional heat generated between the pillar 30 and the bushing 40, the heat flux transmitted upward along the pillar 30 thus reaching the spacer 50a is generally greater than the heat flux transmitted downward along the pillar 30 thus reaching the spacer 50b. Accordingly, in the die unit 100 according to this embodiment, the spacer 50b may have a thinner wall thickness than that of the spacer 50a. If desired, the die unit 100 may only include the spacer 50a, omitting the spacer 50b.

Although the spacer 50 is constituted of a cylindrical single piece in this embodiment, the present invention is not limited to such configuration. A plurality of smaller pieces may be discretely attached to the inner circumferential surface 13 or 23, to thereby constitute the spacer 50.

Hereunder, an operation of the die unit according to this embodiment will be described, referring to a cutting process of the lead 210 of the semiconductor device 200 as an example.

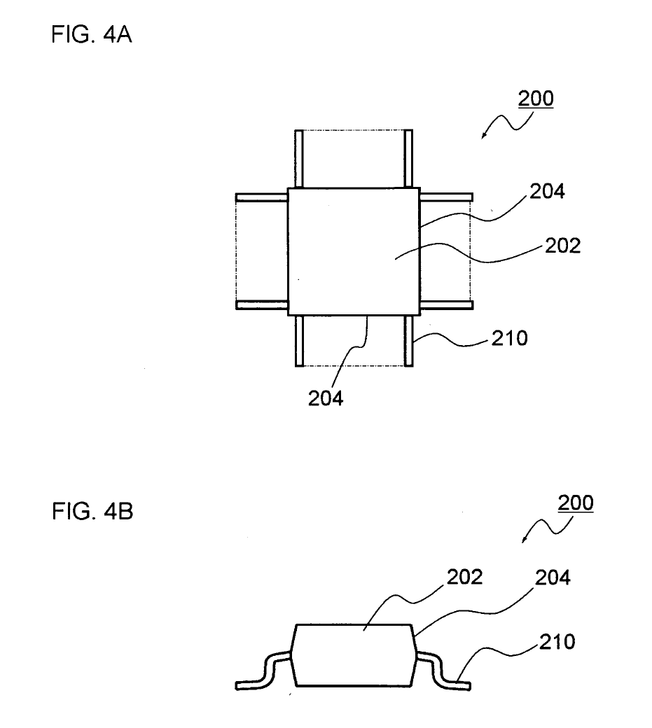

FIGS. 4A and 4B are a schematic plan view and a front view respectively, of the semiconductor device 200 pressed by the die unit 100.

The die unit 100 according to this embodiment may be employed for separating the semiconductor device 200 from a lead frame (not shown), bending the lead 210 in a gullwing shape, and cutting the gullwing-shaped lead 210.

A plurality of outer leads (lead 210) is sticking out from a lateral face 204 of an encapsulating resin 202 enclosing therein a semiconductor chip (not shown). In FIG. 4A, the multitude of leads 210 sticking out from a lateral face of the encapsulating resin 202, and located between the ones at the respective ends, are not shown.

The encapsulating resin 202 is of a rectangular shape in a plan view, and of what is known as a QFP type having the leads 210 sticking out from the four lateral faces 204. In addition to this, the die unit 100 according to this embodiment is also applicable to bending and cutting the leads 210 of an SOP type semiconductor device 200, having the leads 210 sticking out from opposing two lateral faces 204.

The lead 210 that has been bent and cut by the die unit 100 according to this embodiment is formed into the so-called gullwing shape of specified outer dimensions, as shown in FIG. 4B.

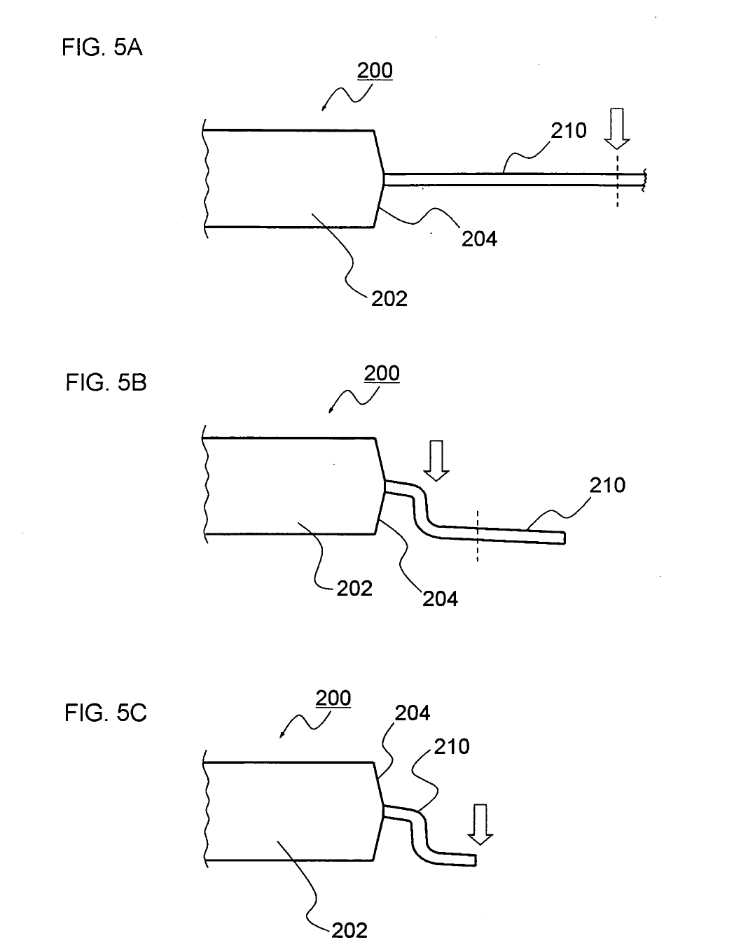

An example of the cutting process of the lead 210 of the semiconductor device 200 is shown in FIGS. 5A to 5C. In these drawings, the left-side portion of the semiconductor device 200 is not shown.

In this example, the lead 210 sticking out from the lateral face 204 of the encapsulating resin 202 is cut away from the lead frame (not shown) in a length slightly exceeding the specified length, as shown in FIG. 5A. Then the lead 210 is bent in a predetermined shape (FIG. 5B), and the lead 210 is cut and finished in the specified size (FIG. 5C).

In FIGS. 5A to 5C, blank arrows indicate the direction of shear force applied to the lead 210 by the die unit 100 according to this embodiment in the bending and cutting process.

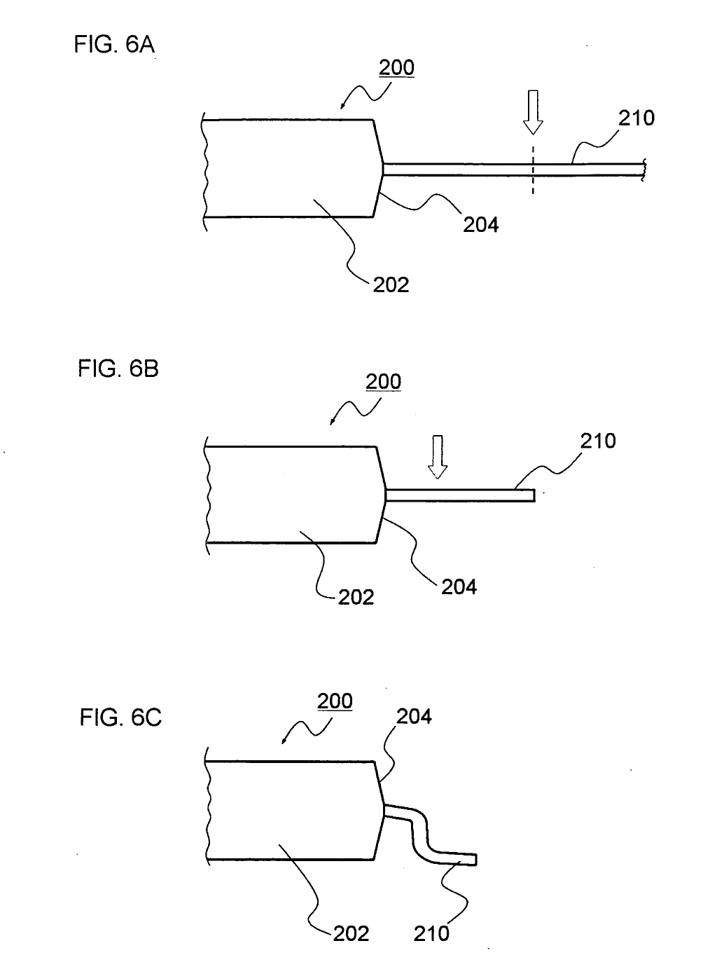

FIGS. 6A to 6C show another example of the cutting process of the lead 210 of the semiconductor device 200. In these drawings, the left-side portion of the semiconductor device 200 is not shown.

In this example, the lead 210 sticking out from the lateral face 204 of the encapsulating resin 202 is cut away from the lead frame (not shown) in a predetermined length, as shown in FIG. 6A. Then the lead 210 is bent in a predetermined shape and finished in the specified size (FIGS. 6B and 6C).

In FIGS. 6A to 6C, blank arrows indicate the direction of shear force applied to the lead 210 by the die unit 100 according to this embodiment in the bending and cutting process.

As shown in FIG. 2, the die element 14 includes slots formed at positions corresponding to the punch 24. When the upper die 20 is made to descend toward the lower die 10 by a motor or a hand, such that the bushing 40 slides along the pillar 30, the blade tip of the punch 24 is introduced into the slot on the die element 14. At this moment, the semiconductor device 200 placed on the die element 14 is subjected to the shear force of the punch 24, so that the lead 210 is bent or cut.

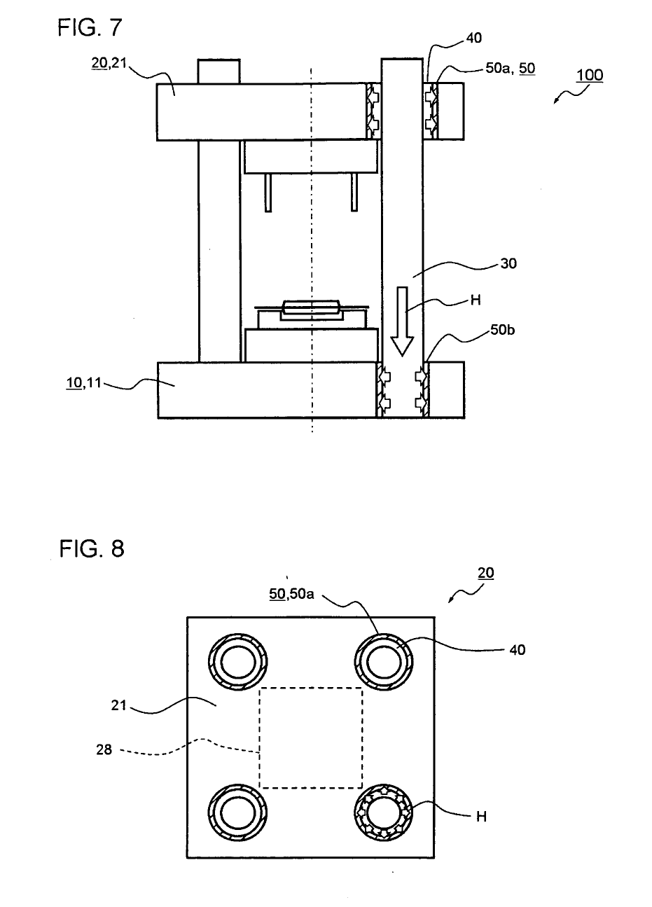

Referring now to FIGS. 14, 15 and FIGS. 7, 8, transmission of frictional heat H in a conventional die unit 300 and in the die unit 100 according to this embodiment will be comparatively described hereunder.

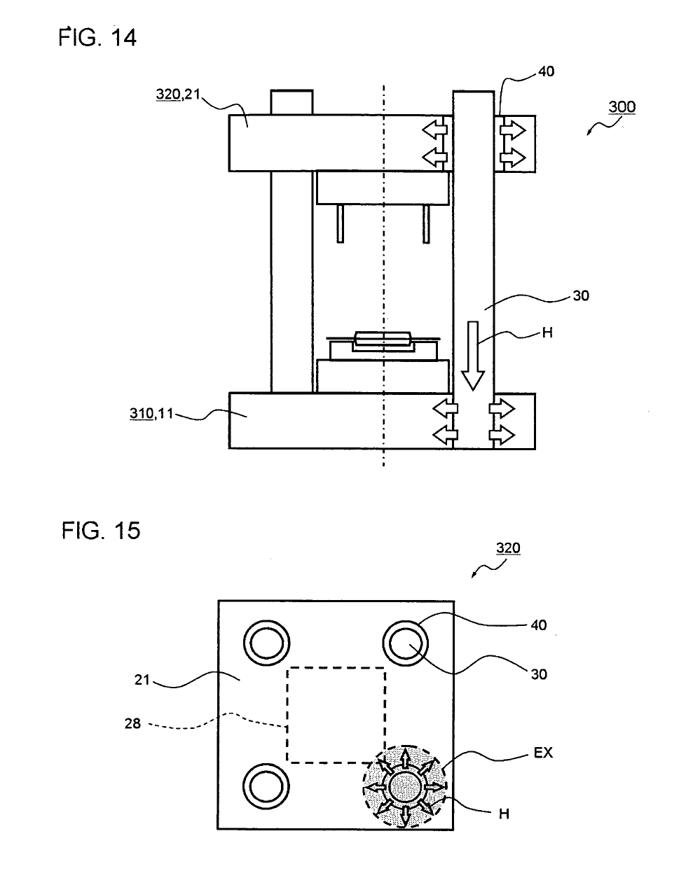

FIG. 14 is a schematic front view showing thermal conduction in the conventional die unit 300 without the spacer 50. The right-hand half of FIG. 14 is a vertical cross-sectional view similarly taken to FIG. 1A.

FIG. 15 is a schematic plan view showing thermal conduction in a conventional upper die 320.

The frictional heat H generated between the pillar 30 and the bushing 40 by the vertical reciprocation of the upper die 20 is, in the case of the conventional die unit 300, directly conducted to the upper die holder 21 through the bushing 40 of the upper die 320, and to the lower die holder 11 of the lower die 310 through the pillar 30, as indicated by a blank arrow in FIG. 14.

Here, the four die guides, each constituted of the pillar 30 and the bushing 40, exhibit different sliding performance from each other because of cutting tolerance and other factors, and hence the amount of the frictional heat H generated on the respective die guide also becomes different from each other. Accordingly, as shown in FIG. 15, the frictional heat H flowing into the upper die holder 21 from the bushing 40 is different at each of the four corners of the upper die holder 21.

Also, in the case of the die unit 300 in which the upper die holder 21 is constituted of an iron-based material, since the iron-based material has relatively low thermal conductivity the frictional heat H conducted to the upper die holder 21 diffuses in the vicinity of the contact interface of the bushing 40, as shown in FIG. 15. Accordingly, a local thermal expansion EX is incurred on the upper die holder 21, which provokes deviation of the position and angle of the punch plate 28.

In contrast, in the case where the upper die holder 21 of the die unit 300 is constituted of an aluminum-based material which has relatively high thermal conductivity, the frictional heat H conducted from the bushing 40 to the upper die holder 21 relatively uniformly diffuses over the plane on the upper die holder 21 presenting a predetermined temperature slope. However, since the aluminum-based material has higher linear expansion coefficient than the iron-based material, a large thermal expansion EX is incurred in the vicinity of the bushing 40, in accordance with the temperature slope.

The foregoing also applies to the lower die holder 11.

In view of the foregoing, in the conventional die unit 300 without the spacer 50, considerable positional deviation is incurred between the upper die 320 and the lower die 310 owing to the local thermal expansion EX taking place around the pillar 30 and the bushing 40, which impedes constantly achieving uniform quality of the work.

FIG. 7 is a schematic front view showing thermal conduction in the conventional die unit 100 with the spacer 50. The right-hand half of FIG. 7 is a vertical cross-sectional view similarly taken to FIG. 1A.

FIG. 8 is a schematic plan view showing thermal conduction in the upper die 20 according to this embodiment. For better understanding, the region corresponding to the spacer 50a is hatched.

As shown in FIGS. 7, 8, the die unit 100 according to this embodiment includes the spacer 50 (50a, 50b) between the bushing 40 and the upper die holder 21 (50a), and between the pillar 30 and the lower die holder 11 (50b), to thereby block the frictional heat H conducted to the upper die holder 21 and the lower die holder 11.

Accordingly, the heat flux released toward outside from the pillar 30 is greater than that introduced to the upper die holder 21 and the lower die holder 11 from the bushing 40 and the pillar 30, and hence the upper die holder 21 and the lower die holder 11 are exempted from the local thermal expansion.

In particular, providing the spacer 50, which is an independent component from the bushing 40, on the outer circumferential surface of the bushing 40 instead of increasing the wall thickness thereof enables restricting the transmission of the frictional heat H at the interface between the bushing 40 and the spacer 50. According to this embodiment, therefore, the heat flux can be effectively restricted from flowing into the upper die holder 21 and the lower die holder 11.

Thus, even with lately developed die units 100 achieving higher and higher pressing speed, the work such as the semiconductor device 200 can be successively subjected to the bending and cutting process with high accuracy.

### Method of Manufacturing the Die Unit

Hereunder, description will be given on a method of manufacturing the die unit 100 according to this embodiment (hereinafter, simply “the method” as the case may be). Providing the spacer 50 on the upper die holder 21 and the lower die holder 11 offers advantages also to the manufacturing process of the upper die 20 and the lower die 10.

The outline of the method is as follows.

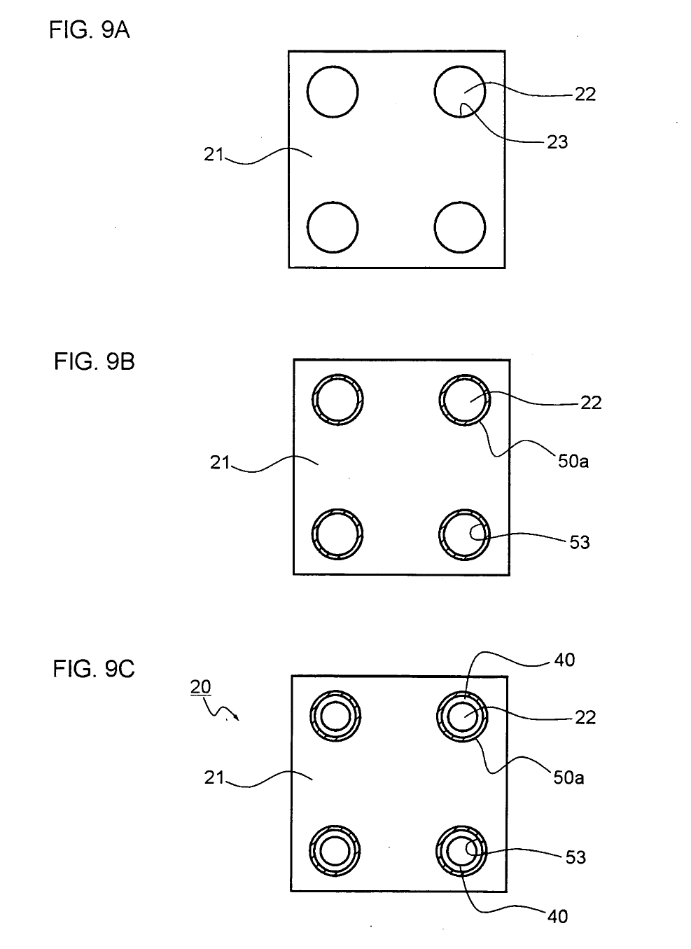

FIGS. 9A to 9C are for explaining the method, from which, however, the process of inserting the pillar to the lower die and through the upper die, and that of mounting the punch plate 28 and the punch 24 (FIG. 1A) on the upper die holder 21 are excluded.

The method includes drilling the upper die, attaching the spacer, cutting the upper die, attaching the bushing, putting the pillar in the lower die, and inserting the pillar through the upper die.

In the drilling process shown in FIG. 9A, the through hole 22 is formed by drilling on the upper die holder 21, with a first positional accuracy.

In the spacer attaching process shown in FIG. 9B, the annular spacer 50a, having lower thermal conductivity than the upper die holder 21, is attached to the through hole 22.

In the upper die cutting process, the inner circumferential surface 53 of the spacer 50a is cut with a second positional accuracy, which is higher than the first positional accuracy.

In the bushing attaching process shown in FIG. 9C, the bushing 40 is attached to the inner circumferential surface 53 of the spacer 50a which has been cut.

In the pillar putting-in process, the pillar 30 is inserted into the base hole 12 formed on the lower die holder 11.

In the pillar inserting process, the pillar 30 is slidably inserted through the bushing 40.

Further details of the foregoing method will be described hereunder.

An aluminum-based material is employed to form the upper die holder 21.

Here, high positioning accuracy between the upper die 20 and the lower die 10 is essentially required in the die unit 100 and the like used for processing the semiconductor device 200, and the relative positioning of the punch 24 and the die element 14 must be adjusted with a tolerance of approx. 3 microns in a strictest case.

Accordingly, for the process of drilling the holes on the upper die holder 21 and the lower die holder 11, an even higher accuracy is inevitably required. It is preferable, therefore, to select a material less susceptible to heat generated in the drilling process, for the upper die holder 21 and the lower die holder 11. In the case where the higher positioning accuracy is required, it is preferable to select an iron-based material which has low thermal conductivity and low linear expansion coefficient.

It is to be noted that the aluminum-based material such as an aluminum alloy has, while being light-weighted and easy to handle, higher thermal conductivity and linear expansion coefficient than the iron-based material, and is hence prone to incur excessive thermal expansion in the cutting process, and besides difficult to be processed with high accuracy because of its soft nature. Thus, in the case of adopting the aluminum-based material, it is difficult to execute the cutting with the accuracy of the order of several microns, because the material is prone to suffer excessive cutting, or seizure due to clogging about a blade.

By the method, therefore, the annular spacer 50 made of the iron-based material is attached to the through hole 22, and then the inner circumferential surface 53 of the spacer 50 is cut and finished with high positional accuracy.

As shown in FIG. 9A, the through hole 22 that fits the outer shape of the spacer 50 is formed by drilling with the first positional accuracy, at four corners of the upper die holder 21. To determine the drilling position of the through hole 22, a first through hole 22 may be designated as a position index to thereby drill the remaining through holes 22 according thereto, or a reference hole (not shown) may be formed as the position index to thereby drill the four through holes 22 according thereto.

For processing the upper die holder 21 according to the method, the same position index serving as the reference of the first and the second positional accuracy may be adopted in common, or different position indices may be adopted for the processing.

The first positional accuracy for drilling the through hole 22 may be set at a general tolerance level. Based on this, it is easy to form the through hole 22 on the upper die holder 21, which is constituted of the aluminum-based material.

In the spacer attaching process, the spacer 50a formed in advance in the annular shape is attached and fixed to the through hole 22. It is preferable to make the inner diameter of the through hole 22 slightly smaller than the outer diameter of the spacer 50a, and to press-insert the spacer 50a into the through hole 22. To fix the spacer 50a, an adhesive for metal may be additionally employed for improving adhesion strength to the inner circumferential surface 23 of the through hole 22.

In the upper die cutting process, the inner circumferential surface 53 of the spacer 50a fitted to the through hole 22 is cut and finished with the second positional accuracy. Since the spacer 50a is made of the iron-based material, it is possible to set the second positional accuracy in the order of submicron.

Therefore, despite employing the aluminum-based material to form the upper die holder 21, the positional accuracy equivalent to that for the iron-based material can be achieved, for attaching the bushing 40.

That is also the case with the lower die 10, and finishing the lower die holder 11 with the spacer 50b attached thereto allows erecting the plurality of pillars 30 on the lower die holder 11 with high positional accuracy.

Specifically, the method may also include forming the base hole 12 on the lower die holder 11 with a third positional accuracy, attaching to the base hole 12 the annular spacer 50b having lower thermal conductivity than the lower die holder 11, and cutting the inner circumferential surface of the spacer 50b with a fourth positional accuracy which is higher than the third positional accuracy.

By the method, the foregoing is followed by the pillar putting-in process, in which the pillars 30 are inserted to the spacer 50b thus finished.

To process the lower die holder 11, the same position index serving as the reference for the third and the fourth positional accuracy may be employed in common, or different position indices may be adopted for the processing.

In the lower die cutting process, the third positional accuracy with which the base hole 12 is to be formed on the lower die holder 11 may be set at a general tolerance level, as the first positional accuracy.

By the method, the base hole 12 is formed as a through hole. This makes the processing easier than forming a blind hole, and besides suppresses fluctuation of the erection angle of the pillars 30.

In the lower die cutting process, the inner circumferential surface of the spacer 50b is cut with the fourth positional accuracy of the order of submicron, as in the cutting process of the upper die holder 21, to thereby finish the spacer 50b.

Thus, the fourth positional accuracy with which the inner circumferential surface of the spacer 50b is cut is higher than the third positional accuracy, and equivalent to the second positional accuracy.

On the upper die holder 21 and the lower die holder 11, the punch plate 28 and the die plate 18 are fixed respectively, at a desired timing. The punch plate 28 and the die plate 18 may be either removably or permanently mounted on the upper die holder 21 and the lower die holder 11, respectively.

In the pillar putting-in process, the pillar 30 is inserted into the spacer 50b, the inner circumferential surface of which has been finished, so that the pillar 30 is fixed in the base hole 12 of the lower die holder 11.

The base hole 12 according to this embodiment is a through hole formed so as to penetrate through the lower die holder 11 thicknesswise thereof, and the pillar 30 may be inserted to the lower die holder 11 either from an upper face side or a lower face side.

The pillar 30 may also include a flange portion formed at a lower end portion, in a diameter larger than that of the inner circumferential surface of the spacer 50b. In this case, the upper end portion of the pillar 30 is to be put into the base hole 12 (spacer 50b) from the lower face side of the lower die holder 11. Upon inserting the pillar 30 through the base hole 12 over the entire length, the flange portion is butted to the lower face of the spacer 50b and thus restricts the pillar 30 from escaping to the upper face side.

In the pillar inserting process, the lower die 10 and the upper die 20 are disposed to oppose each other with the die plate 18 and the punch plate 28 inwardly directed, and the upper end portion of the pillar 30 is slidably inserted through the bushing 40.

Thus, the foregoing method enables attaching the bushing 40 and the pillar 30 with positional accuracy to the upper die holder 21 and the lower die holder 11, constituted of the aluminum-based material which has high thermal conduction, thereby achieving highly accurate positional relationship between the die element 14 and the punch 24.

It is to be noted that the present invention is not limited to the foregoing embodiment, but various modifications and improvements may be made within the scope of the present invention.

### Second Embodiment

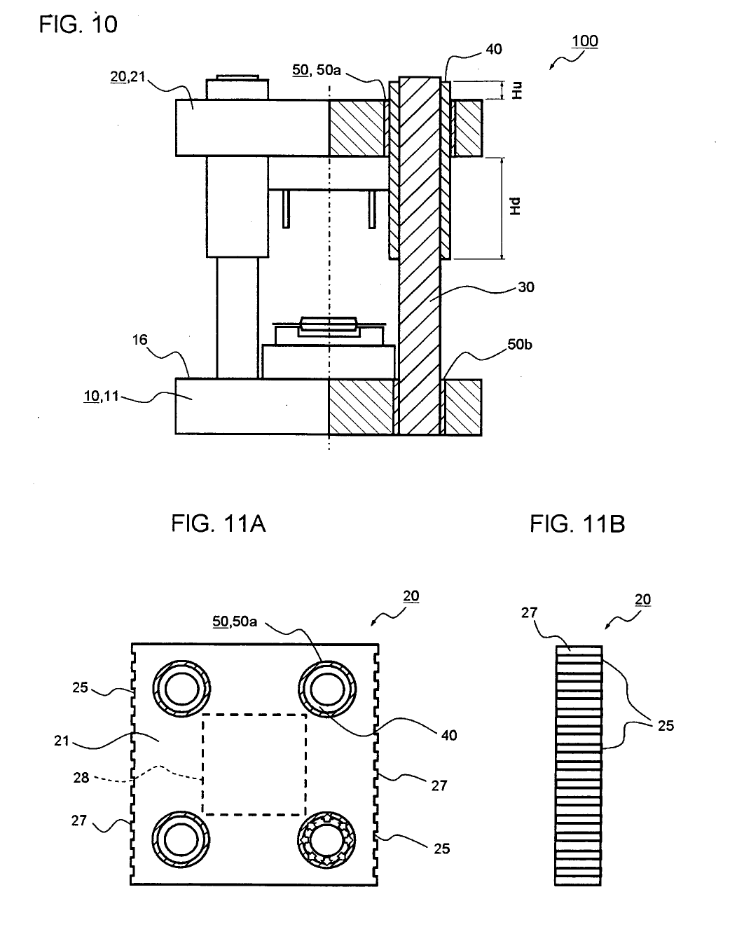

FIG. 10 is a schematic front view of the die unit 100 according to a second embodiment. The right-hand half of FIG. 10 is a vertical cross-sectional view similarly taken to FIG. 1A.

The die unit 100 according to this embodiment has a structure that achieves higher dissipation efficiency of the frictional heat generated from the sliding action of the bushing 40 along the pillar 30.

The upper die 20 according to this embodiment is different from that of the first embodiment in that the bushing 40 extends farther outward from the through hole 22 in both directions.

The state that the bushing 40 extends farther outward from the through hole 22 in both directions herein refers to such state where the bushing 40 is sticking out of the upper die holder 21 in both directions, from the through hole 22. The bushing 40 may be typically formed in a straight tube shape, though a different shape may be adopted.

For example, either or both of the upper and lower end portion of the bushing 40 may be expanded in a flared shape to thereby increase the heat dissipating area, as far as the sliding action of the bushing 40 along the pillar 30 remains undisturbed.

In the die unit 100 according to this embodiment, the bushing 40, disposed such that the upper and lower end portion stick out from the upper and lower face of the upper die holder 21, contacts the ambient air and thereby dissipates the frictional heat generated with the pillar 30. Also, since the bushing 40 has a larger volume and heat capacity than that of the first embodiment, formation of a steep temperature slope can be suppressed in the region between the bushing 40 and the upper die holder 21, from the frictional heat generated by the sliding action along the pillar 30.

The axial length (longitudinal size) of the bushing 40 is not specifically limited.

It is preferable that the outer circumferential surface of the pillar 30 and the inner surface of the bushing 40 remain in full plane-to-plane contact even when the upper die 20 is at an upper dead point. Accordingly, it is preferable to determine an upward projection length Hu of the bushing 40 from the upper face of the upper die holder 21, such that the upper end of the bushing 40 and that of the pillar 30 are at the same height when the upper die 20 is at the upper dead point.

On the other hand, it is preferable to determine a downward projection length Hd of the bushing 40 from the lower face of the upper die holder 21, at a length equal to a clearance between the upper die 20 and the lower die 10 when the former is at a lower dead point, and not longer.

Such configuration provides sufficient heat dissipation capability to the bushing 40, without causing interference of the lower face of the bushing with the upper face 16 of the lower die 10, even when the upper die 20 descends to the lower dead point.

However, increasing the axial length of the bushing 40 leads to an increase in frictional force between the pillar 30 and the bushing 40, and hence it is preferable to appropriately determine the axial length of the bushing 40 in consideration of the processing accuracy of the bushing 40 and the pillar 30.

Between the pillar 30 and the bushing 40, a lubricant may be provided. It is preferable to employ such lubricant that exhibits high heat dissipation and cooling performance, to thereby suppress the generation of the frictional heat itself, in addition to improving the heat dissipation efficiency of the bushing 40.

As specific example, in the field of general lubricants a lubricant oil offers higher heat dissipating and cooling effect than a lubricant grease.

It is preferable to mix a molybdenum-based additive such as organic molybdenum or molybdenum disulfide, in the lubricant oil. In this case a protective lubricant layer is formed over the inner surface of the bushing 40 and the outer surface of the pillar 30, and therefore the heat generation due to the sliding friction can be effectively suppressed.

### Third Embodiment

FIG. 11A is a schematic plan view of the upper die 20 according to this embodiment, and FIG. 11B is a right-side lateral view thereof. For better understanding, the region corresponding to the spacer 50a is hatched in FIG. 11A.

The upper die 20 and the lower die 10 according to this embodiment include a structure that efficiently dissipates the frictional heat introduced to the upper die holder 21 and the lower die holder 11, generated by the sliding friction between the pillar 30 and the bushing 40.

The upper die 20 according to this embodiment includes a plurality of grooves 25 formed so as to extend in the moving direction of the upper die holder 21, on at least one of the lateral faces 27 thereof.

The upper die 20 according to this embodiment, which includes the vertical grooves formed on the lateral face 27 in the thicknesswise direction, i.e. the moving direction, has a larger surface area than the upper die 20 of the first and the second embodiment, and is hence capable of dissipating the heat more efficiently.

In this embodiment, the upper die 20 includes the plurality of grooves 25 aligned side by side, engraved on two opposing lateral faces 27 of the upper die holder 21.

The grooves 25 may be formed on one of the sides of the upper die holder 21, or on all the four sides.

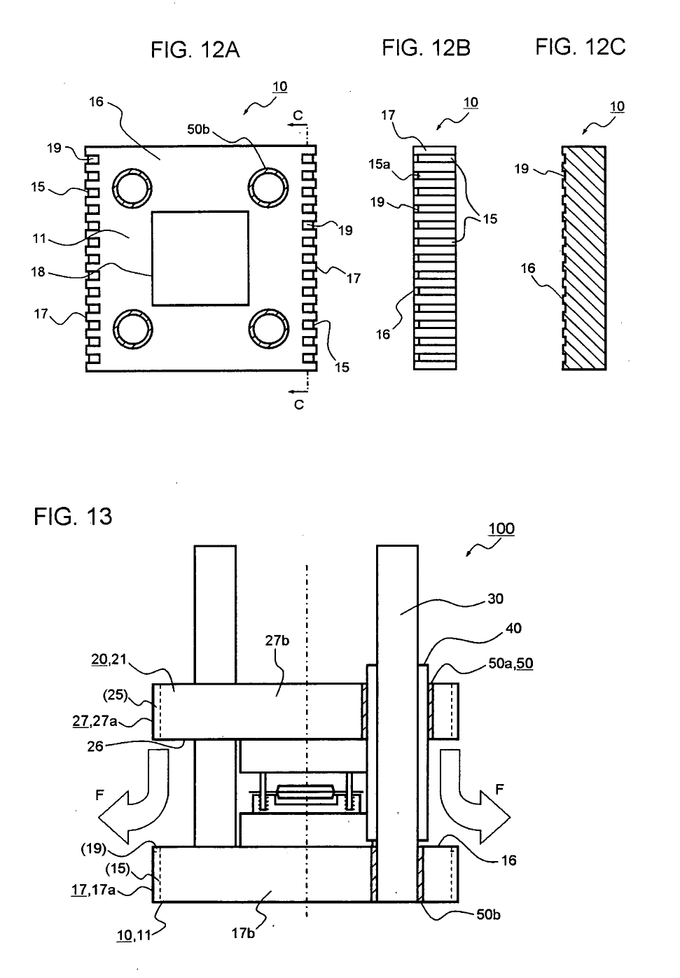

FIG. 12A is a schematic plan view of the lower die 10 according to this embodiment, FIG. 11B is a right-side lateral view thereof, and FIG. 11C is a cross-sectional view taken along a line C-C in FIG. 12A. For better understanding, the region corresponding to the spacer 50b is hatched in FIG. 12A.

The lower die 10 according to this embodiment efficiently dissipates the frictional heat introduced to the lower die holder 11 through the pillar 30.

The lower die 10 according to this embodiment includes a plurality of grooves 15 formed on at least one of the lateral faces 17 of the lower die holder 11, so as to extend in the moving direction of the upper die holder 21.

The lower die 10 according to this embodiment also includes a plurality of indented portions 19 formed on the upper face 16 of the lower die holder 11, so as to communicate with an upper end 15a of each of the grooves 15.

In this embodiment, the lower die 10 includes the plurality of grooves 15 aligned side by side, engraved on two opposing lateral faces 17 of the lower die holder 11.

The grooves 15 may be formed on one of the sides of the lower die holder 11, or on all the four sides.

FIG. 13 is a schematic front view showing how air flows while the die unit 100 according to this embodiment is working.

In the die unit 100 according to this embodiment, the lateral face 27 of the upper die holder 21 and the lateral face 17 of the lower die holder 11, which respectively include the grooves 15, 25, are aligned in the moving a direction of the upper die holder 21.

Now, when the lower die 10 is placed on a work table (not shown) and the upper die 20 is made to descend toward the lower die 10, the lower face 26 of the upper die holder 21 creates a downward flow F of the ambient air, as indicated by blank arrows in FIG. 13.

Meanwhile, the ambient air flows through inside of the groove 25 along the lateral face 27 of the upper die holder 21, to a region above the upper die holder 21. In this process, heat exchange is performed between the grooves 25 and the ambient air, so that the upper die holder 21 can be effectively air-cooled.

Providing the grooves 25 on the lateral face 27 of the upper die holder 21 according to this embodiment enables improving heat exchange efficiency with the ambient air when compared with the upper die holder 21 of the first embodiment, without restricting the area where the punch plate 28 and the die plate 18 are to be mounted.

Also, as shown in FIG. 13, the airflow F reaches the upper face 16 of the lower die holder 11.

Then the airflow F intrudes into the grooves 15 through the indented portion 19 formed on the upper face 16 of the lower die holder 11, so that the lower die holder 11 can also be effectively air-cooled. The indented portion 19 formed on the upper face 16 contributes to conducting the airflow F, which is a downward flow, into the grooves 15.

In the case where the upper die 20 is made to ascend, the airflow F is oppositely directed. To be more detailed, the upper face of the upper die holder 21 creates an upward flow of the ambient air, so that the ambient air is induced to blow upward through the grooves 15, and thus cools the lower die holder 11. With the upper die holder 21 also, the ambient air flows relatively downward with respect to the grooves 25, thereby air-cooling the upper die holder 21.

Thus, the die unit 100 according to this embodiment is capable of constantly air-cooling the lower die holder 11 and the upper die holder 21 utilizing the continuous vertical reciprocation of the upper die 20, thereby efficiently dissipating the frictional heat generated between the bushing 40 and the pillar 30.

Also, disposing in alignment the lateral face 27 of the upper die holder 21 and the lateral face 17 of the lower die holder 11, which respectively include the grooves 15, 25, provides balanced air-cooling effect to the lower die holder 11 and the upper die holder 21. Accordingly, the pillar 30 can be prevented from tilting because of thermal deformation.

In further details, in the die unit 100 according to this embodiment, both the lower die holder 11 and the upper die holder 21 include the grooves 15, 25 on the respective left- and right-hand lateral faces 17a, 27a shown in FIG. 13, but not on the front and rear lateral faces 17b, 27b. In other words, the lateral faces effectively air-cooled to room temperature (lateral faces 17a, 27a) and the lateral faces subjected to relatively wide temperature fluctuation (lateral faces 17b, 27b) are oriented to the same direction in the lower die holder 11 and the upper die holder 21. Such configuration creates the same thermal deformation pattern in the lower die holder 11 and the upper die holder 21, when the frictional heat generated by the bushing 40 and the pillar 30 is conducted to the die holders. Consequently, even though the lower die holder 11 and the upper die holder 21 respectively suffers thermal deformation, deviation in relative position and angle between the die element 14 and the punch 24 can be suppressed, and therefore uniformity in finished quality of the work can be constantly achieved.

It is apparent that the present invention is not limited to the above embodiment, and may be modified and changed without departing from the scope and spirit of the invention.

What is claimed is:

1. A die comprising:
a lower die holder including a base hole;
an upper die holder including a through hole;
a pillar having an end portion inserted to said base hole and the other end portion slidably inserted through said through hole, so as to allow said upper die holder to slide toward and away from said lower die holder;
an annular bushing attached to said through hole so as to slide along said pillar;
a die element and a punch attached to one of said lower die holder and said upper die holder respectively; and
a spacer provided at least one of between an inner circumferential surface of said through hole and said bushing, and between an inner circumferential surface of said base hole and said pillar;
wherein said spacer has lower thermal conductivity than said upper die holder or said lower die holder on which said spacer is provided.

2. The die according to claim 1, wherein said spacer is located between said inner circumferential surface of said through hole and said bushing, and between said inner circumferential surface of said base hole and said pillar.

3. The die according to claim 1, wherein said upper die holder and said lower die holder are constituted essentially of an aluminum-based material, and said spacer is constituted essentially of an iron-based material.

4. The die according to claim 1, wherein said bushing extends outward from said through hole in both directions.

5. The die according to claim 1, wherein said upper die holder includes a groove formed on at least one of lateral faces thereof, so as to extend in a moving direction of said upper die holder.

6. The die according to claim 5, wherein said lower die holder includes a groove formed on at least one of lateral faces thereof, so as to extend in a moving direction of said upper die holder.

7. The die according to claim 6, wherein said lower die holder includes an indented portion formed on an upper face thereof, so as to communicate with an upper end portion of said groove.

8. The die according to claim 6, wherein said lateral face of said upper die holder and said lateral face of said lower die holder respectively including said groove are aligned in said moving direction.

9. A method of manufacturing a die, comprising:
forming a through hole through an upper die holder with a first positional accuracy;
attaching to said through hole an annular spacer having lower thermal conductivity than said upper die holder;
cutting an inner circumferential surface of said spacer with a second positional accuracy higher than said first positional accuracy;
attaching a bushing to said inner circumferential surface of said spacer that has been cut;
inserting a pillar into a base hole provided on a lower die holder; and
slidably inserting said pillar through said bushing.

10. The method according to claim 9, further comprising:
forming said base hole on said lower die holder with a third positional accuracy;
attaching to said base hole another annular spacer having lower thermal conductivity than said lower die holder;
cutting an inner circumferential surface of said another spacer with a fourth positional accuracy which is higher than said third positional accuracy; and
inserting said pillar to said another spacer which has been cut.
